(19) United States
(12) Patent Application Publication
(10) Pub. No.: US 2013/0255071 A1
(43) Pub. Date: Oct. 3, 2013

(54) Method for Producing Surface-Mount Inductor

(71) Applicants: Keita MUNEUCHI, Shiki-shi (JP); Masaaki Totsuka, Tsurugashima-shi (JP); Kunio Sasamori, Higashimatsuyama-shi (JP)

(72) Inventors: Keita MUNEUCHI, Shiki-shi (JP); Masaaki Totsuka, Tsurugashima-shi (JP); Kunio Sasamori, Higashimatsuyama-shi (JP)

(21) Appl. No.: 13/854,590

(22) Filed: Apr. 1, 2013

(30) Foreign Application Priority Data
Mar. 30, 2012 (JP) 2012-079242

(51) Int. Cl. H01F 41/02

(52) U.S. Cl. CPC H01F 41/02
USPC 29/605

(57) ABSTRACT

A method of producing a surface-mount inductor having an external electrode with high connection reliability even in a high-humidity environment is provided.

The method comprises the steps of: forming a coil by winding an electrically-conductive wire having a self-bonding coating; forming a core portion using a sealant comprising metal magnetic powders and a resin so as to encapsulate the coil while allowing each of opposite ends of the coil to be at least partially exposed on a surface of the core portion; applying an electrically-conductive paste containing metal fine particles having a sintering temperature of 250° C. or less onto the surface of the core portion; and forming an underlying electrode on the surface of the core portion by sintering the metal fine particles through a heat treatment of the core portion to achieve electrical conduction with the coil.

### TECHNICAL FIELD

The present invention relates to a method of producing a surface-mount inductor and, more particularly, to a method of forming an external electrode with high connection reliability of the surface-mount inductor.

### BACKGROUND ART

Conventionally, a surface-mount inductor has been used which has an external electrode formed by using an electrically-conductive paste on a chip-like element body. In this type of surface-mount inductor, the external electrode is formed by forming an underlying electrode by applying an electrically-conductive paste on a surface of a resin-molded chip encapsulating a winding wire, curing the paste, and further conducting a plating.

### LIST OF PRIOR ART DOCUMENTS

### Patent Documents

Patent Document 1: JP 2005-116708 A

Patent Document 2: JP 10-284343 A

### SUMMARY OF THE INVENTION

### Object to be Accomplished by the Invention

In such a conventional surface-mount inductor, as an electrically-conductive paste, a type is used which contains a thermosetting resin such as an epoxy resin and dispersion of metal particles such as Ag. In such an electrically-conductive paste, electrical conduction is achieved by contacting the metal particles dispersed in the resin with each other or contacting the metal particles and an electrically-conductive wire, utilizing contraction stress resulting from curing of the thermosetting resin. Since the curing temperature of the thermosetting resin is generally much lower than a sintering temperature of the metal particle, this electrical conduction is achieved as a result of contact with the metal particle. Thus, if the contact with the metal particle is released, the electrical conduction state will be changed.

The resign in the electrically-conductive paste tends to be degraded in a high-humidity environment. In a conventional surface-mount inductor produced by using an ordinary electrically-conductive paste, a DC resistance thereof is likely to vary under a moisture resistance test. It is believed that this is caused in part by the fact that the resin in the electrically-conductive paste is degraded in the high-humidity environment and contact between the metal particles or between the metal particle and an internal electrical conductor is released.

As an alternative method of forming an electrode, there has been known a technique of forming an underlying electrode by sintering metallic powders in the electrically-conductive paste. In this method, as such an electrically-conductive paste, a type is used which is obtained by mixing and kneading metallic powders such as Ag, an inorganic binder such as a glass frit, and an organic vehicle. This electrically-conductive paste is applied to a chip-like element body, and then it is sintered by applying heat at a temperature of 600 to 1000° C. to form the underlying electrode. The metallic powders are sintered with each other through the use of this method. Thus, it is possible to achieve more stable electrical conduction than that achieved by mere connection of the metal particles as described above. However, this method requires an inorganic binder such as a glass frit in the electrically-conductive paste to be melted. Thus, a heat treatment must be conducted at a high temperature such as 600° C. or more. In the case of producing a surface-mount inductor encapsulating a winding wire formed by winding an electrically-conductive wire with a sealant comprising magnetic powders and a resin, a heat treatment at a temperature of more than 250° C. will degrade, for example, a self-bonding coating of the electrically-conductive wire or the resin in the sealant. Therefore, this method cannot be adopted.

It is therefore an object of the present invention to provide a method of producing a surface-mount inductor having an external electrode with high connection reliability even in a high-humidity environment.

### Means to Accomplish the Object

To accomplish the above object, the method of producing a surface-mount inductor according to the present invention comprises the steps of: forming a coil by winding an electrically-conductive wire having a self-bonding coating; forming a core portion using a sealant comprising primarily of metal magnetic powders and a resin so as to encapsulate the coil while allowing each of opposite ends of the coil to be at least partially exposed on a surface of the core portion; applying an electrically-conductive paste containing metal fine particles having a sintering temperature of 250° C. or less onto the surface of the core portion; and forming an underlying electrode on the surface of the core portion by sintering the metal fine particles through a heat treatment of the core portion to achieve electrical conduction with the coil.

### Effect of the Invention

The present invention makes it possible to easily produce a surface-mount inductor having an external electrode with high reliability.

### BRIEF DESCRIPTION OF THE DRAWINGS

FIG. 1 is a perspective view of an air-cored coil for use in a first embodiment of the present invention.

FIG. 2 is a perspective view of a core portion according to the first embodiment of the present invention.

FIG. 3 is a perspective view of the core portion according to the first embodiment of the present invention, where an electrically-conductive paste is applied to the core portion.

FIG. 4 is a perspective view of a surface-mount inductor produced by a method according to the first embodiment of the present invention.

FIG. 5 is a perspective view of a core portion according to a second embodiment of the present invention.

FIG. 6 is a perspective view of the core portion according to the second embodiment of the present invention, where an electrically-conductive paste is applied to the core portion.

FIG. 7 is a perspective view of a surface-mount inductor produced by a method according to the second embodiment of the present invention.

### DESCRIPTION OF EMBODIMENTS

A method of producing a surface-mount inductor according to the present invention will now be described with reference to the drawings.

### First Embodiment

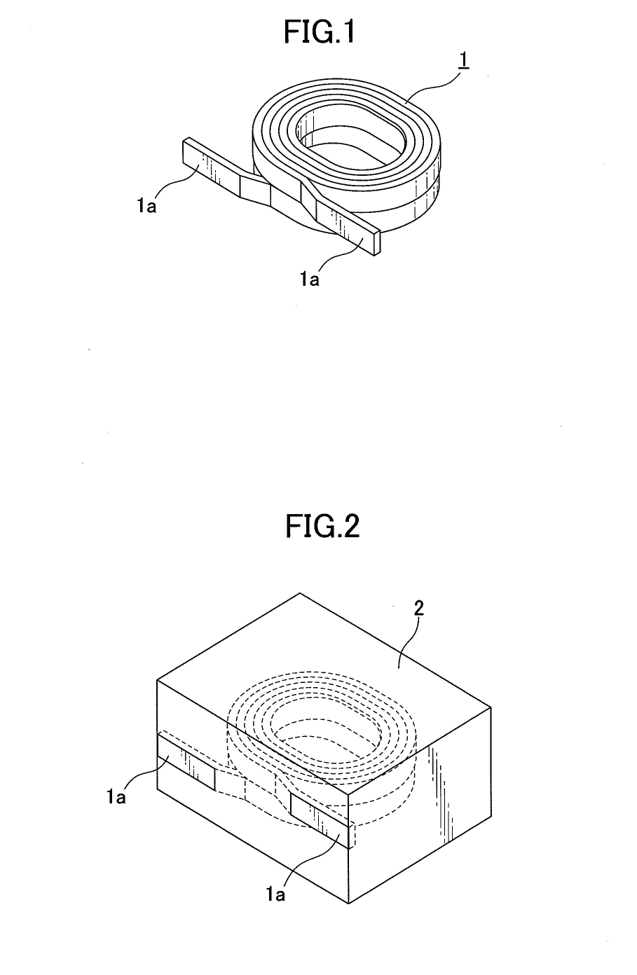

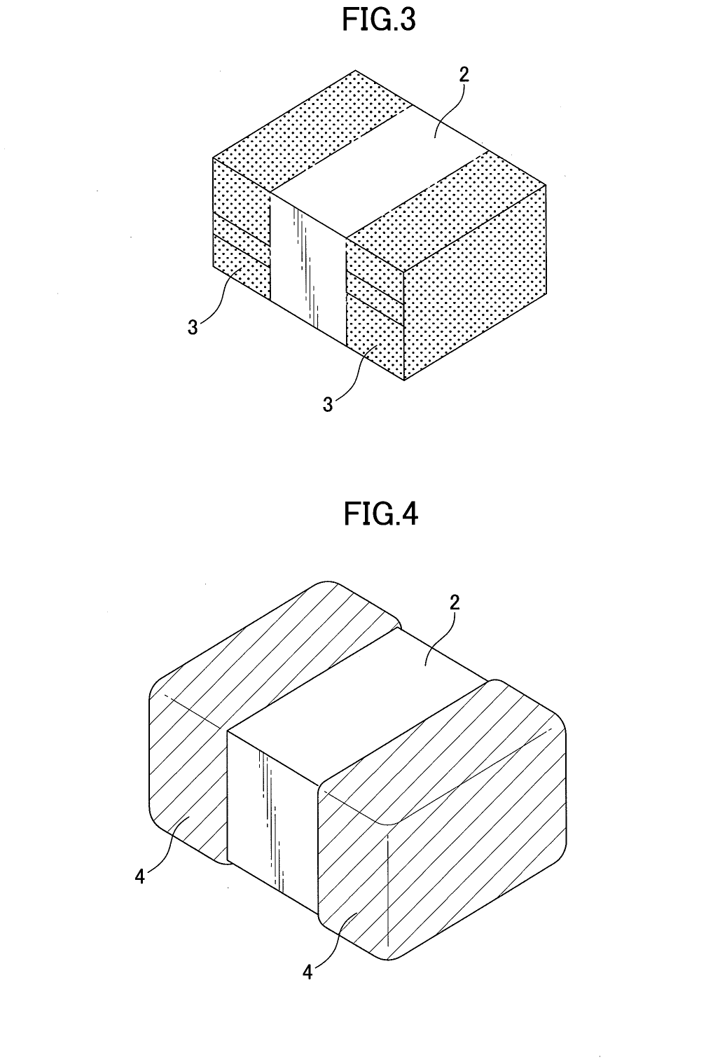

A method of producing a surface-mount inductor according to a first embodiment of the present invention will be described below with reference to FIGS. 1 to 4. FIG. 1 illustrates a perspective view of an air-cored coil for use in the first embodiment of the present invention. FIG. 2 illustrates a perspective view of a core portion of the surface-mount inductor according to the first embodiment of the present invention. FIG. 3 illustrates a perspective view of the core portion according to the first embodiment, where an electrically-conductive paste is applied to the core portion. FIG. 4 illustrates a perspective view of the surface-mount inductor produced by the method according to the first embodiment of the present invention.

Firstly, a coil is produced using an electrically-conductive wire with a rectangular cross-section having a self-bonding coating. As illustrated in FIG. 1, a coil 1 is produced by winding the electrically-conductive wire in two-tiered outward spiral pattern so as to allow its opposite ends 1a to be positioned on an outermost periphery. As the electrically-conductive wire for use in this embodiment, a type which has an imide-modified polyurethane layer as the self-bonding coating is used. The self-bonding coating may be polyamides or polyesters, preferably having a higher heat resistance temperature. Further, while the electrically-conductive wire having a rectangular cross-section is used in this embodiment, it is also possible to use a round wire or a wire having a polygonal cross-section.

Next, a core portion 2 encapsulating the coil as illustrated in FIG. 2 is formed by a compressing molding technique, using, as a sealant, iron-based metal magnetic powders and an epoxy resin which are mixed and granulated to powders. In this case, the coil is formed to allow each of the opposite ends 1a to be exposed on a surface of the core portion 2. While the core portion is produced by the compressing molding technique in this embodiment, it is also possible to produce the core portion by other molding technique such as a powder compacting molding technique.

Then, after removing the coating on a surface of the exposed opposite ends 1a by mechanical stripping, an electrically-conductive paste 3 is applied on a surface of the core portion 2 by a dip technique, as illustrated in FIG. 3. In this embodiment, as an electrically-conductive paste, a type is used which contains Ag fine particles having a particle size of 10 nm or less and solvent such as organic solvent which are mixed and pasted. Metals will have a lowered sintering temperature or melting temperature by size effect when the particle size thereof is reduced below 100 nm. In particular, the sintering temperature or the melting temperature is significantly lowered with a size less than 10 nm. While the Ag fine particle is used in this embodiment, it is also possible to use Au or Cu. Further, while the dip technique is used in this embodiment as a technique for applying the electrically-conductive paste, a printing technique or a potting technique may alternatively be used.

The core portion 2 applied with the electrically-conductive paste 3 is subjected to a heat treatment at 200° C. to cause the core portion 2 to be cured while sintering the Ag fine particles in the electrically-conductive paste 3. Since the Ag fine particle has a particle size of 10 nm or less, it can be easily sintered at such a degree of temperature. Sintering the metal fine particles provides an inter-metallic bond which is stronger than the case with mere contact. This makes it possible to achieve electrical conduction with high connection reliability between the coil and the electrically-conductive paste. Even when metallic powders having a particle size of greater than 100 nm are mixed, the metal fine particles will be in sintered or molten state. This makes it possible to achieve inter-metallic bond which is stronger than the case with mere contact. Further, the heat treatment can be performed at a temperature of 250° C. or less. This reduces damage on the coating of the core portion or the electrically-conductive wire.

Finally, a plate processing is conducted and an external electrode 4 is formed on the surface of the electrically-conductive paste to obtain a surface-mount inductor as illustrated in FIG. 4. It is noted that the electrode formed by the plate processing may be formed by appropriately selecting one or more from materials such as Ni, Sn, Cu, Au and Pd.

### Second Embodiment

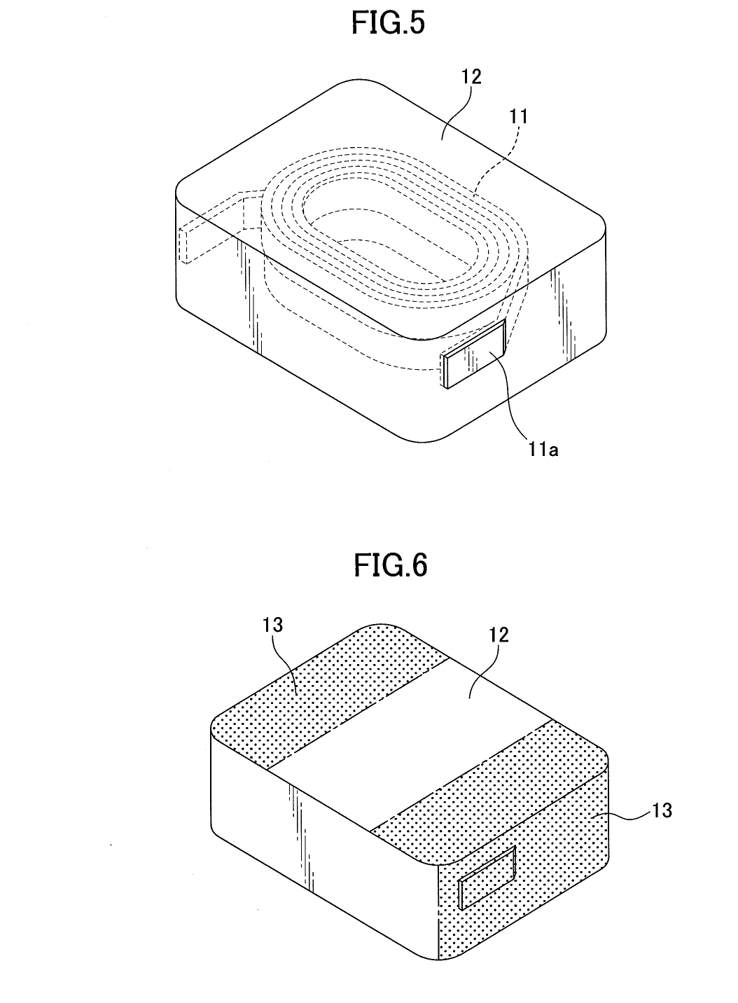

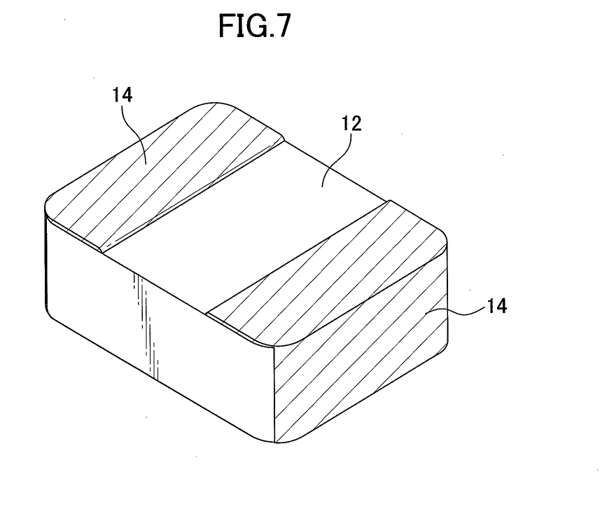

A method of producing a surface-mount inductor according to a second embodiment of the present invention will be described below with reference to FIGS. 5 to 7. FIG. 5 illustrates a perspective view of a core portion of the surface-mount inductor according to the second embodiment of the present invention. FIG. 6 illustrates a perspective view of the core portion according to the second embodiment, where an electrically-conductive paste is applied to the core portion. FIG. 7 illustrates a perspective view of a surface-mount inductor produced by the method according to the second embodiment of the present invention. In the second embodiment, a surface-mount inductor having an L-shaped electrode is produced by using an electrically-conductive paste different than the first embodiment. It is noted that the description of the parts overlapped with the first embodiment will be omitted.

Firstly, a coil 11 is produced by winding the electrically-conductive wire used in the first embodiment in two-tiered outward spiral pattern so as to allow its opposite ends 11a to be positioned on an outermost periphery. In this embodiment, the ends 11a of the coil 11 are led out to be opposed across the wound portion of the coil 11. Next, a core portion 12 encapsulating the coil 11 as illustrated in FIG. 5 is formed by a compressing molding technique, using a sealant having the same composition as used in the first embodiment. In this case, the coil is formed to allow each of the opposite ends 11a to be exposed on opposed side surfaces of the core portion 12.

Then, after removing the coating on a surface of the exposed opposite ends 11a by mechanical stripping, an electrically-conductive paste 13 is applied on a surface of the core portion 12 in an L-shape by a printing technique. In this embodiment, as an electrically-conductive paste, a type is used which contains Ag fine particles having a particle size of 10 nm or less, an Ag particles having a particle size of 0.1 to 10 μm, and an epoxy resin which are mixed and pasted. The electrically-conductive paste is prepared such that the Ag particles having a particle size of 0.1 to 10 μm are contained in the electrically-conductive paste in an amount of 30 wt % based on the total amount of the Ag fine particles having a particle size of 10 nm or less and the Ag particles having a particle size of 0.1 to 10 μm. Containing a 30 to 50 wt % of metal particles having a particle size of 0.1 to 10 μm provides an effect of reducing heat shrinkage at the time of thermal curing as compared to the case with only metallic fine particles having a particle size of less than 100 nm. Further, the small amount of metallic fine particles can also promise reduction in the material cost. Then, the second embodiment uses an electrically-conductive paste containing a resin content. This provides an effect of increasing a fixing strength. In the case of forming an electrode across five surfaces so as to cover the opposite end faces of the core portion as the first embodiment, a certain level of fixing strength can be ensured by an anchor effect even with an electrically-conductive paste of a type of not containing a resin content. However, in the case of a fashion having less electrode area such as an L-shaped electrode or bottom electrode structure, use of the electrically-conductive paste of a type of not containing a resin content may result in detachment of the electrode due to low fixing strength. Therefore, in the case of forming an electrode which has less electrode area and is likely to be detached as the L-shaped electrode, it is preferable to use the electrically-conductive paste of a type of containing a resin content.

Finally, plate processing is conducted and an external electrode 14 is formed on the surface of the electrically-conductive paste to obtain a surface-mount inductor as illustrated in FIG. 7.

In the above embodiments, as a sealant, a type is used which contains iron-based metal magnetic powders as the magnetic powder and an epoxy resin as the resin which are mixed together. Alternatively, the magnetic powder for use in the sealant may be, for example, a ferritic magnetic powder or a magnetic powder that is subjected to surface modification such as formation of insulation coating or surface oxidation. In addition, an inorganic material such as a glass powder may be added. Further, the resin for use in the sealant may be other thermosetting resin such as a polyimide resin or a phenol resin, or may be a thermoplastic resin such as a polyethylene resin or a polyamide resin.

While a type of coil wound in two-tiered spiral pattern is used in the above embodiments, the coil may alternatively be a type of wound in edgewise winding or aligned winding pattern, or in a circular, rectangular, trapezoidal, semicircular shape, or combination thereof in addition to an elliptic shape.

While mechanical stripping is used as a method of stripping the coating on the surface of the ends of the coil in the above embodiments, it is also possible to alternatively use other methods. In addition, the coating on the end portion may be stripped in advance prior to the formation of the core portion.

### EXPLANATION OF CODES

1, 11: coil (1a, 11a: end)
2, 12: core portion
3, 13: electrically-conductive paste
4, 14: external electrode

What is claimed is:

1. A method of producing a surface-mount inductor comprising the steps of:
forming a coil by winding an electrically-conductive wire having a self-bonding coating;
forming a core portion using a sealant comprising primarily of metal magnetic powders and a resin so as to encapsulate the coil while allowing each of opposite ends of the coil to be at least partially exposed on a surface of the core portion;
applying an electrically-conductive paste containing metal fine particles having a sintering temperature of 250° C. or less onto the surface of the core portion; and
forming an underlying electrode on the surface of the core portion by sintering the metal fine particles through a heat treatment of the core portion to achieve electrical conduction with the coil.

2. The method as defined in claim 1, wherein the resin comprises a thermosetting resin, and the underlying electrode is formed by curing the core portion and sintering the metal fine particles through the heat treatment.

3. The method as defined in claim 1, wherein the metal fine particles contain at least one selected from the group consisting of Ag, Au and Cu, and has a particle size of less than 100 nm.

4. The method as defined in claim 3, wherein the electrically-conductive paste further contains metal particles having a particle size of 0.1 to 10 μm, wherein the metal particles are contained in an amount of 30 to 50 wt % based on the total amount of the metal fine particles and the metal particles contained in the electrically-conductive paste.
